(19) United States
(12) Patent Application Publication
(10) Pub. No.: US 2003/0028424 A1
(43) Pub. Date: Feb. 6, 2003

(54) Method and system for the direct delivery of product samples

(75) Inventors: Steven A. Kampff, Newport Beach, CA (US); Michael D. Starkey, Corona, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CATALINA MARKETING INTERNATIONAL, INC., ST. PETERSBURG, FL (US)

(21) Appl. No.: 09/873,185

(22) Filed: Jun. 5, 2001

(51) Int. Cl. G06F 17/60

(52) U.S. Cl. 705/14

(57) ABSTRACT

A method, system, and computer program product for implementing a product sampling program includes a system for performing the steps of determining offers for retailers to participate in a sampling program, transmitting the offers to the retailers, receiving from various retailer computer systems consumer profile data comprising CIDs of customers of the retailers, which data may be in various formats, determining CIDs associated with data meeting consumer profile criteria, and communicating instructions for delivering sample products to consumers associated with selected CIDs.

### BACKGROUND OF THE INVENTION

1. Field of the Invention

The present invention relates generally to the field of marketing. More particularly, the invention relates to marketing by sampling based upon market research.

2. Discussion of the Background

Marketing is the practice of promoting consumer awareness of a product for the purpose of stimulating sales of the product.

Sampling is the practice of providing samples of products to consumers. Product sampling often involves a fulfillment house distributing product samples to large numbers of consumers, even though many of those consumers are unlikely to use the product sample or subsequently purchase items of the sampled product.

Targeting means selecting from a list based upon elements of the list being associated with data that meet certain criteria.

Fulfillment houses pack, prepare, and label samples for postal or courier service delivery, e.g. through the U.S. Postal Service or a private courier service. Examples of fulfillment houses include Valssis, Young America and NuWorld Marketing. Fulfillment house prices are generally based on courier charges of size/weight and packing costs.

There are a wide variety of ways to distribute samples. They include direct mail, door-to-door, in-store distribution and in response to instructions appearing in Sunday newspaper Free Standing Inserts@ (FSIs). The cost of sampling is usually calculated on a cost per thousand (CPM) basis (e.g., $50/cpm) to deliver samples. Product sampling cost is a function of the cost of the product sample delivery method, the cost of obtaining consumer identification data, the cost of selecting consumer identifications, and the cost of delivering to the consumers having the selected identifications.

U.S. Pat. No. 6,021,362 describes a method and apparatus for dispensing sample products and premiums.

U.S. Pat. No. 5,915,243 describes a method and apparatus for delivering promotions to a person or household on the basis of an information profile for that person or household wherein the information profile is formed by collecting responses to questions.

A platform is defined as the hardware system and the system software used by a computer program. Examples of platforms are a client-server platform. The term server refers to any program that offers a service that can be reached over a network. A client refers to an executing program that sends a request to a server and waits for a response from the server. Servers are usually implemented as application level programs. Servers implemented as application programs can execute on any computing system that supports TCP/IP communication. A server for a particular service may execute on a timesharing system along with other programs, or may execute on a personal computer. Multiple servers may offer the same service and may execute on the same machine or on multiple machines. Replica server copies on physically independent machines can be used to increase reliability or improve performance.

A database is a non-redundant collection of interrelated data items that can be shared and used by several different subsystems or other remote computer systems. A database may take a variety of data structure formats which typically comprise composite forms of arrays, records, and simple linked lists as the basic building blocks. Dynamic records may be linked together by pointers to form the basis of a wide variety of data structures.

Computer programers have developed and refined a variety of methods for accessing, manipulating, and disseminating database information over computer networks, such as the Internet. Standard protocols have been developed to communicate over wide area networks (WANs); for example, TCP/IP protocols have been developed for communication over the Internet. Moreover, various programming languages such as Java Database Connectivity (JDBC), Cold Fusion, and ASP have been developed for performing database operations over computer networks. The design and implementation of various methods of database networking and Internet communications are well known, and are described for example in Corner, “Internetworking with TCP/IP Volume I: Principles, Protocols, and Architecture,” 2^{nd} ed., Prentice-Hall, Inc. 1991; Corner and Stevens, “Internetworking with TCP/IP Volume II: Design, Implementation and Internals, “Prentice-Hall, Inc. 1991; Corner and Stevens, Internetworking with TCP/IP Client-Server Programming and Applications,” Prentice-Hall, Inc. 1993; each of which is incorporated herein by reference.

### SUMMARY OF THE INVENTION

The inventors recognized that existing systems do not provide manufacturers a simple method for wide scale geographic, such as national or international, targeted distribution of incentives, such as product samples.

Accordingly, an object of the invention is to provide manufacturers a simple method for wide scale buyographic targeted distribution, (i.e. targeting based upon consumer or household purchase behavior history information), of incentives, and in particular, product samples.

Another object of the invention is to provide a novel computer network implemented method and system for targeted product sampling of various customers each of whose consumer profile data is stored in different computer systems of various retailers.

Another object of the invention is to provide a novel computer network implemented method and system for providing feedback on the effectiveness of targeted sampling promotion programs.

Another object of the present invention is to provide a novel computer network implemented method and system to target qualified consumers in a widespread geographic region, nationally or internationally, such as that covered by a plurality of retailer organizations, based upon consumer profile data meeting manufacturer product sample offer criteria.

Another object of the present invention is to use consumer profile data collected from the frequent shopper buyographic purchase history databases of a plurality of retailers.

Another object of the present invention is to provide a novel computer network implemented method and system to register and provide unique consumer identifiers (CIDs) to consumers of retail establishments.

These and other objects are achieved according to the present invention by providing a novel computer network implemented system and method for distributing product samples to targeted consumers and monitoring actual consumer purchase behavior utilizing the electronic exchange of data to collect information from a plurality of retailers. A preferred embodiment of the method of the invention includes (1) transmitting (over the network computer system or via direct connection) from the central computer system to a retailer's computer system, a manufacturer's sample product program participation request signal defining an offer to the retailer to participate in a manufacturer's sample product offer program and (2) a consumer profile data request signal requesting that a retailer's computer system communicate to the central computer system consumer profile data, (3) transmitting to the central computer a consumer profile data signal containing consumer profile data for collection of consumer profile data by the central computer, (4) optionally automatically determining in an analytics unit associated with the central computer system whether a particular consumer's data contained in the consumer profile data signal meets manufacturer's product sample selection criteria for receiving the manufacturer's product sample.

Preferably, the central computer system stores data indicating a plurality of different data exchange data transmission formats corresponding to the formats used by a plurality of retailer computer systems to transmit consumer profile data, which retail computer system uses which format, and software for interpreting each one of those formats, so that the central computer system can automatically determine from consumer profile data signals from the plurality of retailer computer systems which consumer's profile data meets the manufacturer's product sample selection criteria.

The central computer system may determine which retailers to transmit the program participation request to, and it may tailor generic program criteria to criteria specific to each retailer.

The manufacturer's sample product program participation request signal may contain sample product offer program specifications. The consumer profile data request signal may be transmitted before or after receiving a response from the retailer to the manufacturer's sample product program participation request signal.

In addition, the central computer system or a computer system associated with a fulfillment house preferably is programmed for (5) generating product sample delivery data for delivering product samples to addresses associated with consumers selected to receive samples, and (6) printing delivery paper work for delivering the product sample to that particular consumer, and the fulfillment house provides for (7) associating delivery paper work with product sample packages, and (8) delivering the sample product package to the address for that particular consumer.

A major advantage to the system and method of the invention are that they provide what appears to the manufacturer to be a seamless nationwide or international process for product sampling wherein the manufacturer issues one set of instructions to the entity controlling a central computer system performing the aspects of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing figures, wherein:

FIG. 1 is a block diagram schematically illustrating a system for the direct delivery of product samples to targeted consumers;

FIG. 2 is an illustration of a data structure storing purchase history data of a particular consumer in either a master database or retailer purchase history database;

FIG. 3 is an illustration of a data record storing purchase information associated with a single purchase in the data structure of FIG. 2;

FIG. 4 is an illustration of a targeted consumer profile 706 relating to a targeted consumer's purchase behavior;

FIG. 5 is a high level flow chart showing general process steps for implementing a method of the present invention with the system of FIG. 1;

FIG. 6 is a flow chart showing process steps for selecting consumers and delivering product samples to the selected consumers; and

FIG. 7 is a flow chart showing post product delivery process steps for analyzing the effectiveness of the promotional product sample offer.

### DETAILED DESCRIPTION OF THE PREFERRED EMBODIMENTS EMBODIMENTS OF A SYSTEM OF THE INVENTION

Referring now to the drawings, wherein like reference numerals designate identical or corresponding parts throughout the several views.

System Components

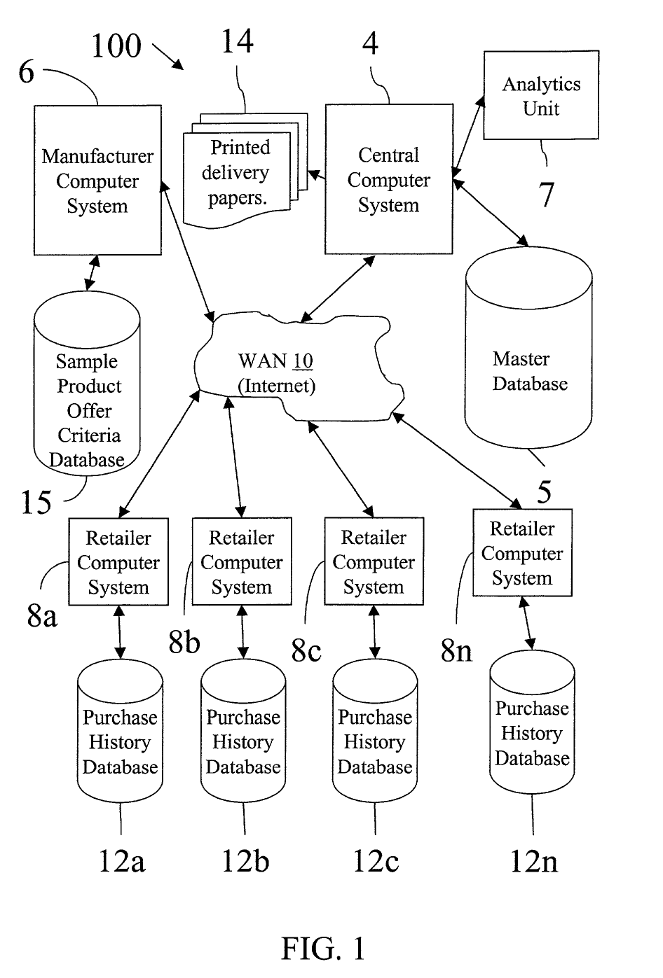

FIG. 1 shows a network computer system 100 of the present invention. The system 100 includes a central computer system 4; a manufacturer computer system 6; multiple retailer computer systems 8a, . . , 8n; and a wide area network (WAN) 10, such as the Internet.

The central computer system 4 includes or can communicate with an analytics unit 7 and a master database 5. The retailer computer systems 8a, . . . , 8n each have an associated purchase history database 12a, . . . 12n storing consumer profile information. The manufacturer computer system 6 may have an associated sample product offer criteria file or database containing criteria for sample product offer programs.

Each one of the central computer system 4, the manufacturer computer system 6, and the retailer computer systems 8a, . . . , 8n may be implemented as one or more general purpose computers, such as an IBM compatible PC running WINDOWS-95™ or UNIX. Each one of the central computer system 4, the manufacturer computer system 6, and the retailer computer systems 8a, . . . , 8n may include a computer housing which houses a motherboard which contains a CPU, memory (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The central computer system 4, the manufacturer computer system 6, and the retailer computer systems 8a, . . . , 8n may also each include plural input devices, (e.g., a keyboard and a mouse), and a display card for controlling a monitor. The central computer system 4, the manufacturer computer system 6, and the retailer computer systems 8a, . . . , 8n may further include a floppy disk drive; other removable media devices (e.g., compact disc, tape, and removable magneto-optical media (not shown)); and a hard disk or other fixed high density media drives, connected using an appropriate device bus (e.g., a SCSI bus, an Enhanced IDE bus, or a Ultra DMA bus (not shown)). Also connected to the same device bus or another device bus, each one of the central computer system 4, manufacturer computer system 6, and the retailer computer systems 8a, . . . , 8n may additionally include a compact disc reader, a compact disc reader/writer unit (not shown) or a compact disc jukebox (not shown). The compact disc may by inserted into a CD caddy or into CD-ROM drives which do not require caddies. Each one of the central computer system 4, the manufacturer computer system 6, and the retailer computer systems 8a, . . . , 8n may be connected to a telephone line modem (not shown) or a network interface card (not shown).

Examples of computer readable media that may form part of the central computer system 4, the manufacturer computer system 6, and the retailers computer systems 8a, . . . , 8n are compact discs, hard disks, floppy disks, tape, magneto-optical disks, PROMs, (EPROM, EEPROM, Flash EPROM), DRAM, SRAM, SDRAM, etc. Software for controlling the hardware of the central computer system 4, the manufacturer computer system 6, and the retailer computer systems 8a, . . . , 8n and for enabling the central computer system 4, the manufacturer computer system 6, and the retailer computer systems 8a, . . . , 8n to interact with a human user may be stored on any one or on a combination of computer readable media. Such software may include, but is not limited to, device drivers, operating systems and user applications, such as development tools. The central computer system 4, the manufacturer computer system 6, and each one of the retailer computer systems 8a, . . . , 8n may be a single computer operating as a server or a plurality of computers acting in a distributed environment. The central computer system 4 is preferably programmed with software to enable it to communicate with each of the other identified computer systems connected to the WAN 10. The central computer system's software enables communication with the manufacturer computer system 6 and the plurality of retailer computer systems 8a, . . . , 8n.

The WAN 10 communications system may include a public telephone system, a cable system, or any system which provides a user access to the Internet, or a system which provides user access to some network of computers other than the Internet.

The central computer system 4, may include or communicate with the analytics unit 7. The analytics unit 7 may be implemented using any desired structure, preferably a programmed computer.

The retailer computer systems 8a, . . . , 8n may be located at or near each retailer location, point-of-sale location, or other location in which offline transactions are made by consumers.

Description of the system as programmed herein means that the code is either software stored in transient memory or hard wired into semiconductor electronic components.

Database Components

Each one of the master database 5, the consumer purchase history databases 12a, . . . 12n, and the manufacturer files or database 15 may be implemented using any desired data structure format with any type of computer connected to any type of storage device. The storage device may include magnetic disks, such as one or more disk drives, optical disks, magneto-optical disks, memory chips, or any other suitable storage device.

Sample Product Offer Criteria Files OR Database

The sample product offer criteria files or database 15 may store data defining some or all of the terms and conditions of manufacturer promotional sample product offer programs. This data includes manufacturer promotional sample product criteria data, which may include (1) consumer profile criteria data, (2) sample product timing criteria data, (3) manufacturer post promotional product sales goals data, (4) post promotional product sales data, (5) pre promotional sample product offer sales data, (6) fulfillment criteria data, and (7) manufacturer contract terms criteria data.

Consumer profile selection criteria data contains criteria that consumer profile data of a consumer must meet to be selected to receive a sample product. Consumer profile criteria data may contain consumer buyographics criteria data containing consumer buyographics criteria, consumer purchase history criteria data, and consumer demographics criteria data.

Consumer buyographics criteria data includes purchase history data, such as purchase frequency and purchase recency data, and may additionally include demographics parameters for age, sex, address and income, and other demographic variables.

Consumer buyograpic purchase history criteria data includes criteria for a particular consumer's total dollar amount of one or more prior purchases, prior purchase of specified products, time since last purchase, time since last purchase of a specified product, brand, or class of product, and prior purchase of product or competing product that is the object of a manufacture's product sampling program.

Sample product offer timing criteria data includes criteria indicating a start date for beginning to receive retailer acceptances to a sample product program participation request, an end date for ending receipt of retailer acceptances to a sample product offer program participation request, a start date to begin selecting consumers for receiving product samples, an end date for ending selection of consumers for receiving product samples, a start date for beginning delivery of sample product packages to the selected consumers, and an end date for ending delivery of product sample packages to the selected consumers, a start date for beginning counting post promotion sample product sales, and an end date for ending counting post promotion product sales.

Manufacturer post promotional sample product offer sales goals data are data indicating the manufacturers anticipated sales in response to the product sample program. Post promotion sample product offer sales data includes sales data for the sampled product for sales occurring after the product sampling promotion program and analysis of that data.

Fulfillment criteria data is data containing any criteria relating to conditions on how the product samples are to be delivered to the selected consumers.

Manufacturer contract terms criteria data are data containing conditions that either the owner of the central computer system 4 or the retailers must agree to as a condition of participating in the product sample promotion program. The manufacturer contract terms data may include retailer profile criteria data for retailers, such as criteria for demographics associated with the locations of the retailer's stores, criteria for markets associated with retailers, and may include data indicating manufacturer preferences for or against certain retailers.

Sample product data may include codes, such as Universal Product Codes (UPCs) indicating sample products. Sample products may be different from products sold to consumers in that they may contain the same substance or product, but be a different package size than that sold to consumers.

Master Database

The master purchase history database 5 may store manufacturer promotional sample product offer criteria data for multiple promotions from multiple manufacturers.

The master database 5 may also store consumer profile data for customers from multiple retailers. Consumer profile data includes (1) CIDs in association with one or more of (2) consumer address data, (3) consumer buyographics data which may include data indicating consumer income bracket, age, residence location or area such as zip code, sex, height, weight and other indicated preferences. Consumer buyographic shopping history data includes data indicating dates and values of each consumer purchase, identification of items purchased, the dates on which items were each purchased, and derivatives of that data. Derivatives of consumer buyographic shopping history data include frequency of purchase, recency of purchase, and relative frequencies of purchased brand goods compared to one another. Consumer buyographic shopping history data and/or consumer demographic data is stored in association with consumer identifications, so that each individual consumer's data can be associated with that consumer's identification.

The master history database 5 may also store retailer participation condition data, pre promotional sample product offer sales data, and post promotional sample product offer sales data. Retailer participation condition data is data defining additional conditions imposed by a retailer necessary for that retailer's participation in a product sample program.

The master database 5 may also store post promotional product sales data. Post promotional sample product sales data is data distinguishing sample product sales between consumers who received product samples and consumers that did not receive products samples, distinguishing time periods based upon when consumers where selected or in fact received a product sample generally referred to as the product sampling time, and including sales data during time periods prior to and after the product sampling time.

The master database 5 may also store post promotional product sales analysis data.

The mater database 5 may also store retailer profile data for retailers, such as demographics data associated with the locations of the retailer's stores or markets associated with retailers.

The master database may store product UPC codes grouped by category, and grouped by manufacturer objective.

Purchase History Databases

Each one of the purchase history databases 12a, . . . , 12n may store consumer profile data including either or both of the consumer purchase history data and the consumer demographic data for consumers that have purchased items at the corresponding retailer's store or stores.

Data Storage Formats

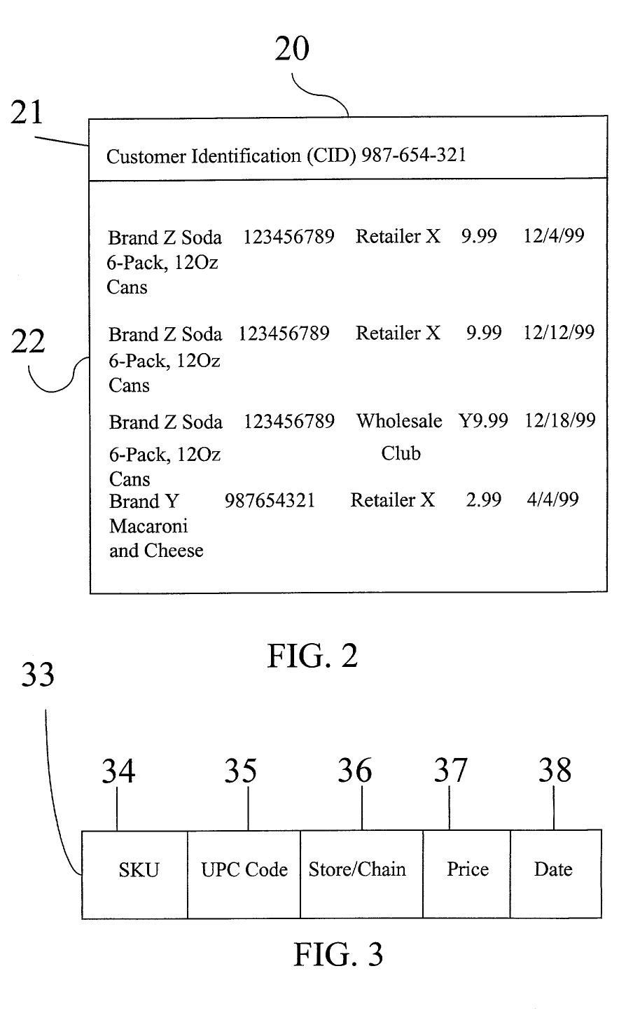

FIG. 2 shows a representation of an exemplary data structure of a master record 20 for storing consumer purchase history data for a particular CID corresponding to a particular consumer. The representation indicates that all data contained in master record 20 is associated with the CID 987-654-321. Data in each row below the CID is associated with one another indicating that that data all relates to the sale of one product item. For example, the data in the first row indicates a sale of a 6-Pack of 12 ounce cans of Brand Z soda, which has Universal Product Code 123456789, by Retailer X for $9.99 on Dec. 4, 1999. A separate master record 20 for each CID is maintained in the master database 5, and/or in at least one of the retailer purchase history databases 12a, . . . , 12n. CIDs for the same consumer in the master database 5 and the purchase history databases 12 may be different from one another but linked to one another. The master record 20 may be implemented as a data structure including a field 21 for storing a consumer's CID as well as a table 22 for identifying and describing each purchase made by the consumer. The table 22 may include one or more linked lists, such as an array of purchase records.

FIG. 3 shows an exemplary purchase record 33 which may be implemented as part of a master record 20. All elements of a data record are associated with one another. The purchase record 33 includes a data field 34 for indicating a product's shelf keeping unit (SKU). Each SKU identifies a distinct product, such as “one 2 liter bottle of Brand Z soda.”

The purchase record 33 also includes a data field 35 for indicating the universal product code (UPC). Each UPC is generally implemented as a bar code on a product. Preferably, the purchase record 33 includes a data field 36 for storing the purchase location, a data field 37 for storing the price per SKU, and a data field 68 for storing purchase date. The purchase date data stored in field 38 may include the purchase date and time-of-day data. Many additional data fields and/or columns, such as the number of items purchased, purchase frequency, or other data field which may be used in performing post promotional sample product offer sales data analysis, may be included in the purchase record 33. Preferably, the master record 20 and/or the purchase record 33 contain data used by the analytics unit 7 to select targeted consumers to receive a product sample.

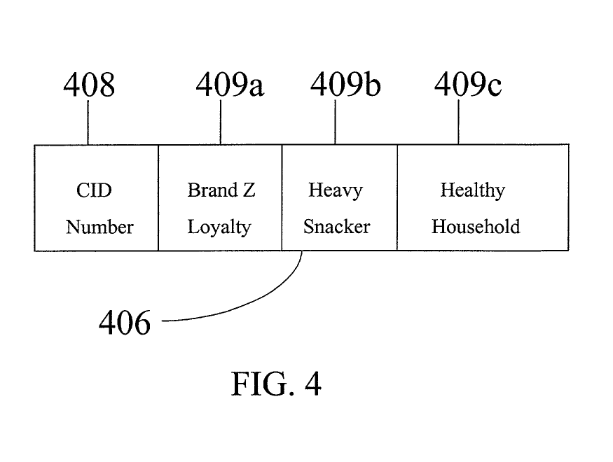

FIG. 4 shows an exemplary illustration of a consumer profile record 406 relating to consumer purchase behavior. The consumer profile record 406 may be a data structure that includes a data field 408 for identifying the consumer. The consumer profile record 406 may include additional data fields for storing consumer purchase history classification data with regard to one or more purchase behavior criteria. The exemplary consumer profile record 406 includes three data fields 409a, 409b, and 409c, for three purchase behavior classifications, such as Brand Z loyalty, heavy Snacker, and Healthy Household, respectively. The purchase behavior classification is based on selected purchase behavior criteria and consumer purchase history data. For example, “Brand Z loyalty”—means the consumer has purchased Brand Z at least 3 times during the last six week period; “Heavy Snacker”—means the consumer has purchased at least 30 units of a food product categorized as a snack food product type within the last six month period; and “Healthy Household”means the consumer has purchased at least 30 units of a product characterized as a nutritional supplement type food product within the last six month period.

The CID may be any identifier that is scanned, read, or otherwise can be entered into a retailer computer system to identify a consumer, for example at checkout. Preferably, the CID is implemented as a bar code so that it can be quickly optically scanned at checkout using an optical scanner. However, many other types of machine readable (or non-machine readable) implementations for storing or displaying identifications may be used, including magnetic strip and computer or memory chips on a card (e.g., smart cards). Examples of possible CIDs are credit card numbers, debit card numbers, social security card numbers, driver's license numbers, checking account numbers, street addresses, names, e-mail addresses, telephone numbers, frequent customer card numbers, shopper card identification numbers, shopper card identifications (SCIDs), or shopper loyalty card numbers issued by one of the retailer computer systems 8a, . . . , 8n, although any suitable form of identification may be used. Alternatively, biometric CID data may be read from a consumer, e.g., retinal pattern, fingerprint, voice recognition, etc.

General Code Components

The central computer system 4 stores the computer code of the present invention for instructing the central computer system 4 how to interact with the manufacturer computer system 6 and retailer computer systems 8a, . . . , 8n, for selecting consumers, and for determining statistics relating to the consumers that subsequently purchased the sampled product. The present invention includes the software enabling the system 100 to perform the methods of this invention by enabling the central computer system 4 to communicate with one or more manufacture computer system 6 and the retailer computer systems 8a, . . . , 8n, to implement the methods of the invention. This software may include code in the form of interpreted or executable software, scripts, interpreters, dynamic link libraries, Java classes, and complete executable software programs.

The analytics unit 7 analyzes consumer profile criteria data and consumer profile data to determine to which consumers to send sample products by determining CIDs associated with consumer profile data that meets the consumer profile criteria data.

The analytics unit 7 may be programmed to receive consumer profile data from the mater database 5. Alternatively, the analytics unit 7 may be programmed to receive consumer profile data stored in the individual retailer consumer history databases 12a, . . . , 12n, bypassing the master database 5.

The retailer computer systems 8a, . . . , 8n record buyographic purchase history data for consumers that present their CIDs at checkout. The buyographic purchase history and demographics data captured by the retailer purchase history databases 12a, . . . , 12n may be periodically communicated to the central computer system 4. The central computer system 4 may automatically periodically copy this data into the master database 5. Any pre or post promotional sample product offer sales data resulting from an analysis performed by the analytics unit 7 is stored in the master database 5. The analysis data or a report generated therefrom may be automatically transmitted to the manufacturer computer system 6 or to the retailer's computer system.

Reports transmitted to retailer computer systems are limited to analysis of consumer profile data obtained from that retailer. Thus, the reports transmitted to different retailers based upon a sampling program differ from one another.

Embodiments of Methods of Using the System of the Invention

The central computer system 4 can interact to exchange data with the manufacturer computer system 6 (or manufacturer representative) and the plurality of plural retailer computer systems 8a, . . . , 8n via the WAN 10 using a client-server type platform or via a direct connection. The central computer system 4 may request and receive data from the manufacturer computer system 6, including manufacturer sample product offer criteria data. The central computer system 4 may also request and receive data from retailer computer systems 8a, . . . , 8n. This data may include data stored in the retailer purchase history databases 12a, . . . , 12n. The data received by the central computer system 4 from the manufacturer computer system 6, and retailer computer systems 8a, . . . , 8n may be stored in master database 5. The central computer system 4 may also respond to requests for data transmitted from the manufacturer computer system 6 or any one of the retailer computer systems 8a, . . . , 8n by sending the requested data to the requesting computer.

The data requested by the manufacturer computer system 6 and transmitted by the central computer system 4 may include post promotional sample product offer sales data and post promotional sample product off sales analysis data.

The data requested by a retailer computer system 8a, . . . , 8n and transmitted to them by the central computer system 4 may include consumer profile criteria data and sample product timing criteria data, and retailer reports.

The retailer computer systems 8a, . . . , 8n may transmit data to the central computer system 4 including consumer profile data, consumer purchase history data, and pre and post promotional sample product offer sales data.

Each one of the retailer computer systems 8a, . . . , 8n transmits data to the central computer system 4 in a defined data exchange data structure format. Some or all of these data exchange data structure formats may be different from one another. The consumer purchase history databases 12a, . . . , 12n may each define a different data structure storage formats. Some or all of these data structure storage formats may be different from one another. The data exchange data structure format in which a retailer's computer system transmits consumer profile data to the central computer system 4 may depend upon the data structure storage format of the retailer's consumer purchase history database. Several exemplary data structures utilized for the exchange of information between retailers and the central computer system are as follows:

### EXAMPLE 1

House 2 Home Record Layout for Wallace

| | |
|---|---|
| Full Name | 050 |
| First Name | 030 |
| Middle Initial | 001 |
| Last Name | 030 |
| Address 1 | 050 |
| Address 2 | 050 |
| City | 040 |
| State | 002 |
| Zip | 010 |
| Store | 010 |
| Other | 020 |
| Carrier Route | 004 |
| Delivery Point | 002 |
| H2H Barcode | 024 |
| Postnet Barcode | 012 |
| Sack/Tray Information | 012 |
| CR/LF | 002 |
| Total Record Length | 349 |

### EXAMPLE 2

Structure for database: Market Logic
Number of data records: 3,500

| Field Description | Type | Width | Dec | Index |
|---|---|---|---|---|
| 1 ZIPCODE | Character | 10 | | N |
| 2 CARRT | Character | 4 | | N |
| 3 FNAME | Character | 15 | | N |
| 4 MNAME | Character | 15 | | N |
| ′5 LNAME | Character | 20 | | N |
| 6 NAME1 | Character | 30 | | N |
| 7 ADDRESS2 | Character | 10 | | N |
| 8 ADDRESS1 | Character | 30 | | N |
| 9 CITY | Character | 16 | | N |
| 10 STATE | Character | 2 | | N |
| ** Total ** | | 153 | | |

### EXAMPLE 3

FILE-AID 8.0 PRINT FACILITY 08:10:46 Page 1

| FIELD LEVEL/NAME | PICTURE | FLD | START | END | LENGTH |
|---|---|---|---|---|---|
| 5 MKT-MAIL-RECORD | | | 1 | 200 | 200 |
| 5 MKTM-ARCHER-ID | X(10) | 1 | 1 | 10 | 10 |
| 5 MKTM-PROMOTION-NUMBER | X(12) | 2 | 11 | 22 | 12 |
| 5 MKTM-KEY | X | 3 | 23 | 23 | 1 |
| 5 MKTM-PHONE | X(10) | 4 | 24 | 33 | 10 |
| 5 MKTM-ZIPCODE | X(5) | 5 | 34 | 38 | 5 |
| 5 MKTM-ZIPCODE-4 | X(4) | 6 | 39 | 42 | 4 |
| 5 MKTM-DELIVERY-PT-BAR-CODE | XX | 7 | 43 | 44 | 2 |
| 5 MKTM-NAME | X(30) | 8 | 45 | 74 | 30 |
| 5 MKTM-ADDRESS-STREET | X(30) | 9 | 75 | 104 | 30 |
| 5 MKTM-ADDRESS-2 | X(30) | 10 | 105 | 134 | 30 |
| 5 MKTM-CITY | X(20) | 11 | 135 | 154 | 20 |
| 5 MKTM-CARRIER-ROUTE | X(4) | 12 | 155 | 158 | 4 |
| 5 MKTM-STATE | XX | 13 | 159 | 160 | 2 |
| 5 MKTM-LOT | X(4) | 14 | 161 | 164 | 4 |
| 5 MKTM-LOT-ORDER | X | 15 | 165 | 165 | 1 |
| 5 MKTM-OTHER | X(17) | 16 | 166 | 182 | 17 |
| 5 MKTM-OTHER2 | X(18) | 17 | 183 | 200 | 18 |

### EXAMPLE 4

Lettershop Output File Formats

4.01 Overview

MarketEXPERT produces two output files in support of a targeted mailing: 1) the Offer Definition file which, for each offer code number, contains the text description of the offer along with other information and 2) the Mailing List file which contains the name, address and other mailing information about each recipient along with a list of the offer codes the recipient is to receive. The offer codes in the Mailing List file correspond to the offers defined in the Offer Definition file.

4.02 File Format Rules

The following rules apply to both files:

A. ASCII format records are variable length. Each record is terminated with a “new line” character (hex code Oa).

B. EBCDIC format records have a fixed length of 350 bytes. Since the required length of the data in any record is always less than this amount, all records are padded with spaces to this length.

C. All data fields, including number fields, contain either ASCII or EBCDIC characters. There are no binary values in the file (except for the “new line” at the end of each record in an ASCII format file).

D. All numbers (except for the record count field) are represented by six digits, right justified, left padded with zeros.

E. Character fields are padded on the right to their defined length with blanks.

F. There are no separators between fields or terminating characters at the end of records or at the end of the file.

4.03 Offer Definition File

This file contains information required to print or display an offer.

4.031 Header Record

| FIELD NAME | TYPE | OFFSET | LENGTH | DESCRIPTION |
|---|---|---|---|---|
| RCDTYPE | CHAR | 1 | 2 | Header record type, |
| RCDCNT | NUM10 | 3 | 10 | value = ′01′ Count of |
| | | | | the number of records |
| | | | | in this file (this |
| | | | | record is #1) |
| FILEDATE | CHAR | 13 | 10 | Date and time this file |
| | | | | was created |
| | | | | (MMDDYYhhmm) |
| FILLER | 23 | 1 or 328 | | New line if ASCII |
| | | | | format or space pad if |
| | | | | EBCDIC |

4.032 Offer Detail Record

| FIELD NAME | TYPE | OFFSET | LENGTH | DESCRIPTION |
|---|---|---|---|---|
| RCDTYPE | CHAR | 1 | 2 | Header record type, |
| | | | | value = ′02′ |
| OFRCODE | NUM | 3 | 6 | Unique number |
| | | | | identifying the offer. |
| | | | | Note that OFRCODEs |
| | | | | will not always start |
| | | | | at 1. |
| OFRTYPE | CHAR | 9 | 1 | Code describing the |
| | | | | offer's purchase |
| | | | | conditions, as follows: |
| | | | | 1 = cents off UPC list |
| | | | | 2 = % off UPC list |
| | | | | 3 = cents off every- |
| | | | | thing in a department |
| | | | | 4 = % off everything |
| | | | | in a department |
| | | | | 5 = any product in |
| | | | | UPC list free |
| OFRVALUE | NUM | 10 | 6 | Value of the offer in |
| | | | | pennies. |
| OFRSTART | CHAR | 16 | 10 | Date and time when |
| | | | | the offer becomes |
| | | | | effective |
| | | | | (MMDDYYhhmm) |
| OFREND | CHAR | 26 | 10 | Date and time when |
| | | | | the offer ends |
| | | | | (MMDDYYhhmm) |
| OFRDESC | CHAR | 36 | 24 | Short description of |
| | | | | the offer |
| OFRTXT1 | CHAR | 60 | 60 | Line 1 of offer |
| | | | | description |
| OFRTXT2 | CHAR | 120 | 60 | Line 2 of offer |
| | | | | description |
| OFRTXT3 | CHAR | 180 | 60 | Line 3 of offer |
| | | | | description |
| UPC | CHAR | 240 | 20 | UPC number to bar |
| | | | | code on the coupon |
| | | | | or offer. |
| FILLER | 260 | 1 or 91 | | New line if ASCII |
| | | | | format or space pad |
| | | | | if EBCDIC. |

4.033 End of File Record

| FIELD NAME | TYPE | OFFSET | LENGTH | DESCRIPTION |
|---|---|---|---|---|
| RCDTYPE | CHAR | 1 | 2 | EOF record type, |
| | | | | value = ′03′ |
| FILLER | | 3 | 1 or 348 | New line if ASCII |
| | | | | format or space |
| | | | | pad if EBCDIC. |

4.04 Mailing List File

This file contains the name, address, letter type and offers to be distributed to each household.

4.041 Header Record

| FIELD NAME | TYPE | OFFSET | LENGTH | DESCRIPTION |
|---|---|---|---|---|
| RCDTYPE | CHAR | 1 | 2 | Header record type, |
| | | | | value = ′04′ |
| RCDCNT | NUM | 3 | 10 | Count of the number |
| | 10 | | | of records in this file |
| | | | | (this record is #1) |
| FILEDATE | CHAR | 13 | 10 | Date and time this file |
| | | | | was created |
| | | | | (MMDDYYhhmm) |
| FILLER | 23 | 1 or 328 | | New line if ASCII for- |
| | | | | mat or space pad if |
| | | | | EBCDIC. |

4.042 Mailing Record

| FIELD NAME | TYPE | OFFSET | LENGTH | DESCRIPTION |
|---|---|---|---|---|
| RCDTYPE | CHAR | 1 | 2 | Mailing record type, |
| | | | | value = ′05 |
| PGMNAM | CHAR | 3 | 15 | Identifying name of |
| | | | | this mailing. |
| LTRSHOP | CHAR | 18 | 20 | Name of the lettershop |
| | | | | receiving this file. |
| ENAM | CHAR | 38 | 15 | Name of the mail |
| | | | | piece to be received |
| | | | | by the household. |
| POSID | CHAR | 53 | 24 | The primary card |
| | | | | number the household |
| | | | | uses for identification. |
| TITLE | CHAR | 77 | 5 | Recipient's title (Mrs., |
| | | | | Mr., etc) |
| LASTNM | CHAR | 82 | 20 | Recipient's last name |
| FIRSTNM | CHAR | 102 | 14 | Recipient's first name |
| MI | CHAR | 116 | 1 | Recipient's middle |
| | | | | initial |
| SFX | CHAR | 117 | 5 | Name suffix (Sr, Jr, |
| | | | | etc) |
| SNAM | CHAR | 122 | 50 | Street Name |
| SCNDRY | CHAR | 172 | 20 | Secondary address |
| | | | | (apt #, etc) |
| CITY | CHAR | 192 | 18 | City |
| STATE | CHAR | 210 | 2 | State |
| ZIP | CHAR | 212 | 9 | Zip + 4 |
| CROUT | CHAR | 221 | 4 | Postal carrier route |
| | | | | code |
| DPBC | CHAR | 225 | 2 | Delivery point bar |
| | | | | code |
| OFFER1 | NUM | 227 | 6 | Offer 1 (zero for no |
| | | | | offer) |
| OFFER2 | NUM | 233 | 6 | Offer 2 (zero for no |
| | | | | offer) |
| OFFER3 | NUM | 239 | 6 | Offer 3 (zero for no |
| | | | | offer) |
| OFFER4 | NUM | 245 | 6 | Offer 4 (zero for no |
| | | | | offer) |
| OFFER5 | NUM | 251 | 6 | Offer 5 (zero for no |
| | | | | offer) |
| OFFER6 | NUM | 257 | 6 | Offer 6 (zero for no |
| | | | | offer) |
| OFFER7 | NUM | 263 | 6 | Offer 7 (zero for no |
| | | | | offer) |
| OFFER8 | NUM | 269 | 6 | Offer 8 (zero for no |
| | | | | offer) |
| OFFER9 | NUM | 275 | 6 | Offer 9 (zero for no |
| | | | | offer) |
| OFFER10 | NUM | 281 | 6 | Offer 10 (zero for no |
| | | | | offer) |
| OFFER11 | NUM | 287 | 6 | Offer 11 (zero for no |
| | | | | offer) |
| OFFER12 | NUM | 293 | 6 | Offer 12 (zero for no |
| | | | | offer) |
| ACSKEY | CHAR | 299 | 16 | USPS ACS keyline |
| HHDOL | NUM | 315 | 10 | Total Value of |
| | | | | OFFERS on this |
| | | | | Record. Present only |
| | | | | if SYSCTL |
| | | | | parameter “HHDOL” |
| | | | | is set to 1. Absence |
| | | | | affects offset of |
| | | | | FILLER, and makes |
| | | | | FILLER longer if |
| | | | | EBCDIC. |
| FILLER | 325 | | 1 or 26 | New line if ASCII |
| | | | | format or space pad |
| | | | | if EBCDIC. |

4.043 End of File Record

| FIELD NAME | TYPE | OFFSET | LENGTH | DESCRIPTION |
|---|---|---|---|---|
| RCDTYPE | CHAR | 1 | 2 | EOF record type, |
| | | | | value = ′06′ |
| FILLER | | 3 | 1 or 348 | New line if ASCII |
| | | | | format or space pad |
| | | | | if EBCDIC. |

4.05 Using Microsoft EXCEL to print Lettershop Files

You can use the following tools to print small quantities of mailings on a laser printer, from a Windows PC or Apple Macintosh, using Microsoft EXCEL 5.0:

A Unix batch program, lscvt, which can convert standard targeted list output files into delimited ASCII files which can be read into an EXCEL spreadsheet. If more than one (max. of four) lettershop input file name is passed to lscvt, it will merge offers for customers who are common between the files.

A prototype EXCEL spread sheet, cpnproto.xls, which contains a prototype coupon layout, along with Visual Basic based Tools Menu entries, to print a single coupon sheet or an entire series of coupons based on importing the output files created by lscvt.

The following simple sequence can be used to convert a standard MarketEXPERT lettershop file into an delimited input file, which can be read into Microsoft EXCEL and used to print customer mailings:

4.1. Use MarketEXPERT menu 5 to define your offers and targeted list as usual. Offer text lines 1 thru 3 can be imported and printed directly on the coupons you create. The number of characters of print per line will depend on the layout of your coupons and the fonts installed for your printer. However, for two up coupons, twenty five to thirty characters per line seems to be the limit.

4.2. Run Build Targeted List as usual.

4.3. Run Copy List to File with the default output file format, “ASCII for Unix.”

4.4. From the Unix $ prompt, run lscvt, as follows:

$lscvt outnm lsnm [lsnm2 . . . lsnm4]

where: outunm is the name prefix you give the delimited output files created by lscvt.

Two files are actually created, outnm.ofr containing the offer definitions and outnm.lst containing the offer qualifications, card number, name and address of each customer to receive the mailing.

lsnm is the name of the first targeted list output file to be converted (created by Copy Targeted List to file). lsnm really consists of lsnm.a of and lsnm.a.ml, but only enter the prefix up to the first “.”. 116

lsnm2 thru lsnm4 are the optional names of one to three additional targeted list files to be merged with lsnm in the delimited output. Typically, each additional lettershop file would contain different offers but the same customers. However, neither condition is a requirement of lscvt. Both offers and customers are merged in the delimited output.

Remember to specify the directory path listed on the Copy Targeted List screen when specifying lsnm [lsnm2 . . . lsnm4].

4.5. Copy the delimited output files to diskette. If the output will be processed on a Windows PC, then it must be converted to DOS file format first, using the MarketEXPERT doscvt utility, as follows:

$doscvt outnm.lst

$doscvt outnm.ofr ofr.dos

The above two lines will convert delimited customer list and offer definition files to DOS format equivalents. Unix and Macintosh text files have the same format, so this isn't necessary if you are printing with the Mac.

You can use the Unix doscp command to copy the files to a DOS format diskette, as follows:

$doscp lst.dos a:

$doscp ofr.dos a:

4.6. Take the diskette created in step 4 to your PC or Mac and copy the two files into the EXCEL sub-directory or folder as appropriate. Launch EXCEL and load the cpnproto sheet. Use the following steps to import and print the coupons:

Read the offer definitions:

Select File Open and enter ofr.dos as the file name, click OK

Text Import Wizard Step 1 will display, with delimited checked, click Next

Change delimiters from TAB to Semicolon, click next

Click Finish to read the offers into columns A thru D of a new sheet. They must be copied to the cpnproto sheet.

Drag across A1 to Dn where n is the number of the last row of offer definitions. Select Edit Copy.

Select Window, cpnproto. Drag over H2 to K2. Select Edit Paste to copy the offer definitions into the main sheet.

Read the mailing list:

Select File Open and enter lst.dos as the file name, click OK

Text Import Wizard Step 1 will display, with delimited checked, click Next

Change delimiters from TAB to Semicolon, click next

Move the window display right to the 17th column, which contains the customer card number. This will be the column just to the left of the formatted name. Click on the heading for the column, which should say General. Then select Text in the area above, labeled Column Data Format. This step is necessary to prevent card numbers from being converted to floating point number representation.

Click Finish to read the offers into columns A thru T of a new sheet. Then they must be copied to the cpnproto sheet.

Drag across A1 to Un where n is the number of the last row of mailing list entries.

Select Edit Copy:

Select Window, cpnproto. Click on L2. Select Edit Paste to copy the offer definitions into the main sheet. Depending on the size of the list you may be asked: “Selection is too large. Continue without Undo?” Click OK.

Print a test coupon:

Pull down Tools, and select Print One Coupon. Customer list information starts in row 2, so just click on OK to print the first entry.

Pull down tools and select Print ALL Imported Coupons to print the entire list.

Your pretty much on your own from here. Printing will be determined by the characteristics of your printer, its setup, fonts available, the format of the coupon mailer you want to print, etc. The EXCEL spread sheet provides a prototype from which you can start, but you may have to modify the coupon layout in cells A1 to G73 or the print tools in Module 2.

The central computer system 4 preferably is programed to recognize the data exchange data structure format of each retailer computer sytem 8a, . . . , 8n. This allows the central computer system 4 to automatically retrieve particular data parameters from the data fields of the data exchange data structure format. This in turn allows the analytics unit 7 to compare data to manufacturer sample product offer criteria data, to identify CIDs that meet the criteria. The selected CIDs of consumers are stored in the master consumer buyographic purchase history database 5 in a manner indicating that the selected consumers should receive product samples.

The central computer system 4 may perform list cleaning on the consumer data in the master database 6, for example by performing validation checks on consumer address and email address data.

The analytics unit 7 may analyze consumer profile data to determine useful criteria for manufacturer's to use in product sample programs. For example the analytics unit 7 can use historical data indicating the effect of prior product sample programs and the demographics and purchase history data on consumer purchases to determine an anticipated effect on sales of products resulting from a sample product program, and use that anticipated effect to determine consumer profile criteria data that will result in the sales goal data.

In one example, the analytics unit 7 determines the average time period between consumers' purchases of a type of good. The analytics unit 7 identifies consumers who purchased that type of good but not for the brand of good being offered in the sampling program, in a prior time period about equal to the determined time period. Then, the analytics unit 7 uses that criteria to select customers for receiving a sample product.

As another example, a manufacturer may define sales goals data as a five percent increase in sales in a six month period after the sampling program. The analytics unit 7 may determine that product sample offers to consumers who have previously not bought the product being sampled or that have bought a competitor product twice in the past six months are fifty percent more likely to purchase the sampled product at-least once in the six months after the program if provided with a sample during the program. Based upon that data and the pre promotion sale of the product to be sampled, the analytics unit 7 can determine how many product samples need to be distributed the consumers who have not previously bought the sampled product or who have bought a competitor product in the past six months in order to achieve the sales goal identified in the sales goal data.

Consumer profile criteria for selecting consumers to receive product samples may include buyographic data relating to purchase history, such as the frequency or recency of product purchase, and may additionally include demographics criteria for age, sex, address zip code, state, country, and income. A preferred embodiment of the method and system of the invention may rely solely on buyographic consumer or household purchase history criteria, such as the existence of one or more prior purchases during a prior time period of the product being sampled or of a competitive product to the product being sampled, as consumer profile selection criteria data.

The manufacturer computer system 6 may transmit consumer profile criteria data and retailer profile criteria data to the central computer system 4. The central computer system 4 communicates this criteria data to the analytics unit 7. The analytics unit 7 compares the criteria data either immediately upon receipt or upon occurrence of a specified event, command, or a specified time, to consumer profile data and, if retailer profile criteria data exists, to the retailer associated with the consumer profile criteria data.

Some or all of the manufacturer promotional data may be manually input into the central computer system 4, the manufacturer computer system 6, or the retailer computer systems 8a, . . . , 8n by a user using a keyboard, mouse, or suitable data entry mechanism. In addition, some or all of this data may be transmitted between the central computer system 4, manufacturer computer system 6, and retailer computer systems 8a, . . . , 8n upon entry of a user command.

The manufacturer promotional sample product criteria data, and particularly the consumer profile criteria data, consumer buyographic purchase history selection criteria data, and retailer profile criteria data may be based, at least in part, upon an analysis by the analytics unit 7 of consumer profile data. That analysis may determine criteria anticipated to result in the largest increase in sales of product per sample of product distributed based upon stored data indicating the magnitude of response based upon retailer and consumer profile data.

Since the master database stores at which retailer each product sale occurs, the criteria anticipated to result in the largest increase in sales of product per sample of product distributed may vary from retailer to retailer, and therefore the central computer system 6 may determine different consumer profile selection criteria to apply to CIDs associated with different retailers.

The analytics unit 7 may determine changes in sales volume of non-sampled products using product sales data of products and/or brands competing with the product being sampled. Post promotional sample product offer sales data may be compared with manufacturer pre promotional sample product offer sales goals data, such as total unit sales, market share, to determine the effectiveness of the sampling program, and to identify the effect sampling upon consumer buying habits, broken down by buyographic product purchase history categories.

The analytics unit 7 may analyze post promotional product sales data of products including competing products and brands in connection with the sales of sampled product, to determine the effect of the sampling program on market share for the type of product that was sampled, and to determine the effectiveness of the sample product program in achieving the manufacturer's sales goals. Post promotional product sample sales data may be collected for any defined period of time in which such analysis may provide useful information to a manufacturer regarding sales of product. Typically, post promotional sample product offer sales data is collected from one day after the promotion begins until six months after the promotion ends. However any period of time determined suitable for analyzing effectiveness may be used. Additionally, the analytics unit 7 may continuously or periodically analyze post promotional sample product offer sales data, and it may be programmed to determine when and if to proceed or provide an indication to proceed with a subsequent promotional sample product offer program for the same product previously the subject of such a program. For example, a subsequent program could be automatically triggered in response to a detection by analytics unit 7 of a drop of ten percent in sampled product sales or market share.

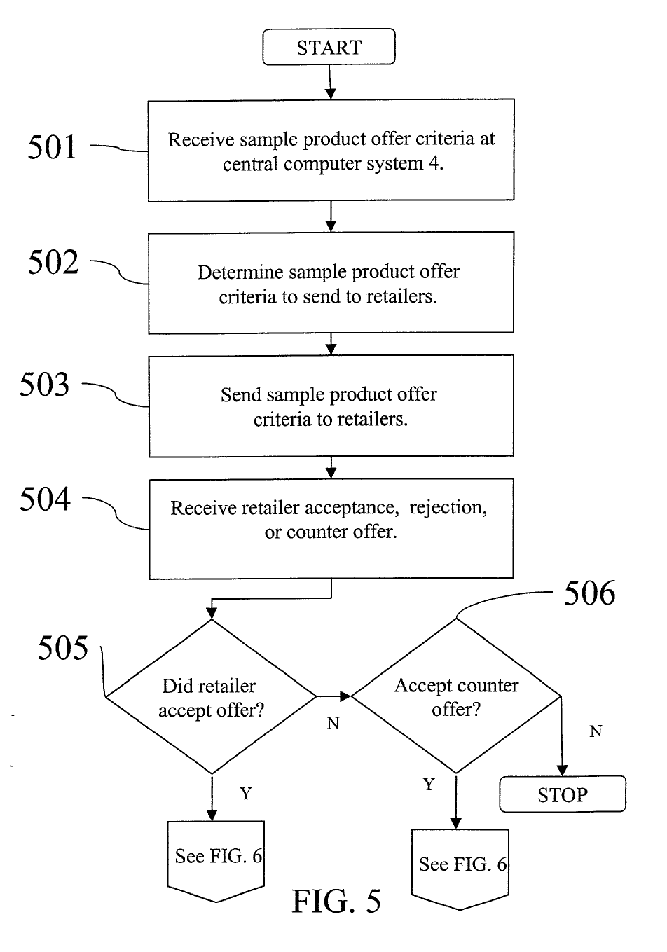

FIG. 5 shows a flow chart of the general process steps for implementing an embodiment of the method of the invention.

In step 501, the central computer system 4 receives from the manufacturer computer system 6 manufacturer sample product offer criteria data for the sample product offer program to the central computer system 4 over the WAN 10. The central computer system 6 stores this data.

In step 502, the central computer system 4 determines what sample product offer criteria data to send to the retailer computer systems 8a, . . . , 8n. Preferably, central computer system determines to send certain consumer profile criterial data, sample product timing criteria data, and the portion of the manufacturer terms criteria data relating to the conditions that the retailers must comply with, to the retailer computer systems 8a, . . . , 8n. Alternatively, the manufacturer may send to the central computer system 6 manufacturer post promotional sales goals data instead of completely specifying the consumer profile criteria data, and allow the central computer system 6 to determine certain consumer profile criteria data to achieve those sales goals. The central computer system 6 will then determine the remaining consumer profile criteria data, based upon analysis, preferably in the analytics unit 7, of data indicating the effectiveness of prior sampling programs on affecting consumer purchasing. The sample product offer criteria to send to the retailer computer systems 8a, . . . , 8n may be based at least in part upon the identity of the retailer computer system and the availability of fulfillment houses to fulfill anticipated sampling orders. The central computer system 4 will also determine to which retailers' consumers to send offers based upon retailer profile criteria data and retailer profile data.

In step 503, the central computer system 4 communicates sample product offer criteria data from step 502 via the WAN 10 to retailer computer systems 8a, . . . , 8n. This data defines an offer to retailers to participate in the promotional sample product offer.

In step 504, the central computer system 4 receives from one of the retailer computer systems 8a, . . . , 8n a response indicating whether the retailer accepts or rejects an offer to participate in the sample product offer program to the central computer system 4. A rejection response may include retailer defined conditional data, such as alternative sample product offer timing criteria data, that the manufacturer must agree to for the retailer to participate in the promotional sample program. A retailer's rejection response containing such conditional data defines a counter offer. The response is either an acceptance, rejection, or a conditional data counter offer. An acceptance constitutes a contract. The indication of acceptance may be transmission to the central computer system 6 of consumer profile data.

In step 505, the central computer system 4 determines whether the retailer accepted the offer.

In step 506, the central computer system 4 determines whether retailer conditional data from a retailer computer contains conditions within limits provided by the manufacturer, as my be specified in the manufacturer promotional sample product criteria data. If within limits, it is acceptable, and the central computer system 4 transmits an acceptance signal to the particular retailer's computer system that sent the conditional data. This acceptance constitutes a binding contract. Hence, the central computer system 4 enables the entity operating it to enter into contracts with retailers based upon the retailers individual conditions by automatically responding to retailer conditional data. Alternatively, the users of the central computer system could respond to conditional data based upon their review of that data.

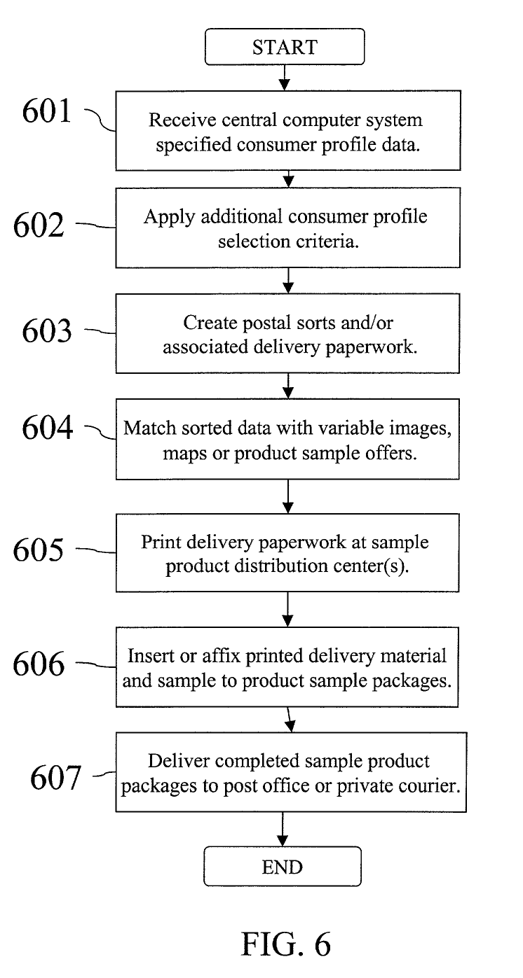

FIG. 6 shows a flow chart of the general process steps that may be used when proceeding with a contracted promotional sample product offer program.

In step 601, the central computer system 4 receives CIDs and associated specified consumer profile data from the retailer computer systems 8a, . . . , 8n. The specified consumer profile data may contain specified data fields (such as purchase history for one or more specified products). The specified data fields may be specified to the retailer computer systems 8a, . . . 8n by the central computer system e.g. during steps 503-506.

In step 602, the central computer system 4 optionally determines which of the CIDs associated data meets additional consumer profile criteria. These additional consumer profile criteria data may be in addition to specifications of consumer profile criteria forming the basis of the consumer profile data that was transmitted by the retailer computer systems 8a, . . . , 8n to the central computer system 4 in step 601. Once the consumer records meeting all consumer profile criteria have been identified, the addresses associated with those records may be retrieved to facilitate sending the samples to consumers.

In step 603, the central computer system 4 generates postal sorts and/or associated delivery paperwork, dependent upon the fulfillment criteria. Alternatively, at step 603 or any one of steps 604 and 605, the central computer 4 may transmit consumer records containing information necessary to transmit samples to addresses associated with the CIDs to a computer (not shown) of a fulfillment house, in which case the fulfillment house's computer and equipment perform step 603 and the following steps.

In step 604, the central computer system 4 matches sorted data with variable images, maps or product sample offers.

In step 605, the central computer system 4 sends print files to printer(s) at product sample distribution centers. The print files contain, for example, instructions to print addresses on envelopes.

In step 606, automated machinery or distribution center personal insert or affix printed delivery material to product sample postal or delivery packages.

In step 607, completed product sample packages are delivered to the post office, private courier, or to a location where consumers can pick them up.

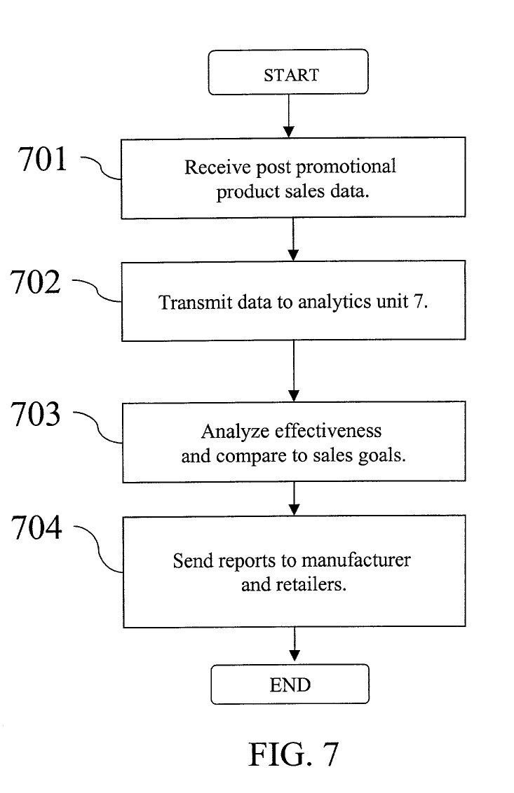

FIG. 7 shows a flow chart of a preferred embodiment of a method of the invention.

In step 701, the retailer computer systems 8a, . . . , 8n communicate post promotional product sales data to the central computer system 4 for storage in the master database 5.

In step 702, the central computer system 4 communicates post promotional product sales data to the analytics unit 7.

In step 703, the analytics unit 7 analyzes the post promotional product sales data to determine the effectiveness of the sampling program and compares that effectiveness to post promotional product sales goals data to determine whether goals were met. Manufacturer or retailer payment may be based upon whether goals were met.

In step 704, the central computer system 4 communicates data relating to the results of the analysis of the effectiveness of the sample product program to the manufacturer computer system 6 and/or retailer computer systems.

Many of the method steps of the invention may involve actions taken by users of the central computer system 4, the manufacturer computer system 6, and the retailer computer systems 8a, . . . , 8n, instead of autonomously. For example, an alternative embodiment of the method of the invention may include the following steps.

In step 1, one or more users associated with the manufacturer of the product of the sample product offer selects manufacturer sample product offer criteria data. The user inputs the selected data into the manufacturer computer system 6 using any suitable data input device, such as a keyboard, a mouse, a scanner, a voice recognition unit, a magnetic storage medium, or an optical storage medium.

In step 2, one or more users associated with the manufacturer communicates manufacturer sample product criteria data by any one of written message, facsimile, courier, email, magnetic storage medium, optical storage medium or telephonic voice communications, to one or more users associated with the central computer system 4.

In step 3, one or more users associated with the central computer system 4 inputs the received manufacturer sample product offer criteria data into the central computer system 4, using any suitable data input device, such as a keyboard, a mouse, a scanner, a voice recognition unit, a magnetic storage medium, or an optical storage medium.

In step 4, one or more users associated with the central computer system 4 communicates selected manufacturer sample product offer criteria data by written message, facsimile, courier, email, magnetic storage medium, optical storage medium or verbal telephonic voice communications, to one or more human responsible entities associated with at least one of a plurality of retailers as an offer to participate in the sample product program.

In step 5, one or more users associated with one of the retailers transmits to the central computer system 4 or a user of the central computer system 4 a response to the offer.

In step 6, one or more users associated with each one of the multiple retailers generates sample product offer invitation response data indicating the retailer's acceptance or rejection of the invitation to participate in the sample product program wherein the response data may include any retailer conditional data.

In step 7, one or more users associated with one of the multiple retailers accepting the invitation to participate in the sample product offer program, communicates data stored on the consumer purchase history database 12a, . . . , 12n of the participating retailers by any suitable means of communication, such as a hard copy printout, magnetic storage medium copy, an optical storage medium copy, or by electronic transmission over a communication line or network to one or more users associated with the central computer system 4.

In step 8, one or more users associated with the central computer system 4 inputs data received from the retailer consumer purchase history databases 12a, . . . , 12n into the central computer system 4 for storage in the master consumer purchase history database 5 using any suitable manual data input device, such as a keyboard, a mouse, a scanner, a voice recognition unit, a magnetic storage medium, or an optical storage medium.

In step 9, the analytics unit 7 selects the CIDs of consumers.

In step 10, a computer generates postal sorts and/or associated delivery paperwork.

In step 11, a computer matches sorted data with variable images, maps or product sample offers.

In step 12, a computer system prints delivery paperwork to one or more printers at product sample distribution center(s).

In step 13, automated machinery or personal at sample distribution center(s) insert or affix printed delivery paperwork and samples to product sample packages.

In step 14, the completed product sample packages are delivered to the post office or private courier.

Alternatives to delivery by mail or courier are to notify the customer at their address, telephone number, when they use an identification code to log on to a web site, or when identified at checkout that a free sample is available for pickup at a specified location. If at a point of sale terminal, the free sample may be delivered by the cashier to the consumer there.

Further, consumer purchase history data may be stored in one or more databases other than the master database 5 or the individual purchase history databases 12a, . . . , 12n. For example, the databases may be associated with other computers or organizations than the retail organizations 8a, . . . , 8n.

Obviously, numerous modifications and variations of the present invention are possible in light of the above teachings. Accordingly, the inventors do not intend to be limited by the specific embodiments of the invention disclosed above.

What is claimed as new and desired to be secured by Letters Patent of the United States is:

1. A computer network implemented system for implementing product sampling programs, comprising:
a central computer system;
a communications medium over which the central computer system can communicate with each one of a plurality of retailer computer systems;
wherein said central computer system is programmed to:
determine, based at least in part on manufacturer promotional sample product criteria data, first offer data constituting a first offer for a first retailer to participate in a sampling program;
determine, based at least in part on manufacturer promotional sample product criteria data, second offer data constituting a second offer for a second retailer to participate in a sampling program;
transmit said first offer data to a first retailer computer system of said plurality of retailer computer systems;
transmit said second offer data to a second retailer computer system of said plurality of retailer computer systems;
receive from said first retailer computer system first retailer consumer profile data comprising CIDs of customers of said first retailer;
receive from said second retailer computer system second retailer consumer profile data comprising CIDs of customers of said second retailer;
determine from said first retailer consumer profile data, first retailer selected CIDs;
determine from said second retailer consumer profile data, second retailer selected CIDs;
wherein said first retailer selected CIDs are CIDs having data associated with them that satisfy consumer profile criteria data, wherein said consumer profile criteria are based at least in part upon said manufacturer promotional sample product criteria data;
wherein said second retailer selected CIDs are CIDs having data associated with them that satisfy consumer profile criteria, wherein said consumer profile criteria are based at least in part upon said manufacturer promotional sample product criteria data;
communicate instructions how to deliver sample products to consumers associated with said first retailer selected CIDs and said second retailer selected CIDs.

2. The system of claim 1 wherein said central computer system is further programmed to:
receive from said first retailer computer system first retailer offer response data indicating whether a first retailer has accept, rejected, or counter offered said first offer;
receive from said second retailer computer system second retailer offer response data indicating whether a second retailer has accept, rejected, or counter offered said second offer;

3. The system of claim 1 wherein said central computer system is further programmed to:
receive from said first one of said retailer computer systems first retailer consumer profile data in a first data exchange data transmission format and interpret that data based upon predetermined specification of said first one of said retailer computer systems' first data exchange data transmission format; and
receive from said second one of said retailer computer systems second retailer consumer profile data in a second data exchange data transmission format and interpret that data based upon predetermined specification of said second one of said retailer computer systems' second data exchange data transmission format.

4. The system of claim 1 wherein said central computer system is further programmed to:
determine based upon said manufacturer promotional sample product criteria data and retailer identification data, offer data constituting different criteria to different retailers.

5. The system of claim 1 wherein said central computer system is further programmed to:
determine based upon said manufacturer promotional sample product criteria data and fulfillment house availability data, offer data constituting said first offer.

6. The system of claim 1 wherein said central computer system is further programmed to:
if said first offer has been counter offered, determine whether to accept said counter offer based upon said manufacturer promotional sample product criteria data, and, if said determination is to accept said counter offer, then to communicate that acceptance to said first one of said retailer computer systems.

7. The system of claim 1 wherein said central computer system is further programmed to:
transmit to said first retailer computer system consumer profile criteria data containing first retailer consumer profile criteria and a prompt to said first retailer computer system to transmit to the central computer system consumer profile data meeting said first retailer consumer profile criteria.

8. The system of claim 7 wherein said central computer system is further programmed to:
receive consumer profile data meeting said first retailer consumer profile criteria; and
determine CIDs from said first retailer consumer profile data that are associated with consumer profile data that meets additional consumer profile criteria, wherein said additional consumer profile criteria are in addition to consumer profile criteria transmitted to said first retailer computer system.

9. The system of claim 8 wherein said additional consumer profile criteria is retailer dependent.

10. The system of claim 8 wherein said additional consumer profile criteria contains consumer demographics criteria.

11. The system of claim 8 wherein said additional consumer profile criteria contains consumer purchase history criteria.

12. The system of claim 1 further comprising a manufacturer computer system and wherein said central computer system is programmed to:
receive from said manufacturer computer system manufacturer promotional sample product criteria data defining a request for said central computer system to solicit contracts to implement a sampling program with retailers.

13. The system of claim 1 wherein said a central computer system is programmed to:
determine CIDs having data associated with them that satisfy consumer profile criteria data, wherein said consumer profile criteria data is based at least in part on manufacturer promotional sample product criteria data.

14. The system of claim 1 further comprising said plurality of retailer computer systems, and wherein said first retailer computer system is programmed to determine CIDs having data associated with them that satisfy criteria contained in consumer profile criteria data transmitted by said central computer system to said first retailer computer system, wherein said consumer profile criteria data is based at least in part on manufacturer promotional sample product criteria data.

15. The system of claim 1 further comprising an analytics unit for analyzing data to determine CIDs meeting criteria contained in consumer profile criteria data, in communication with said central computer system.

16. The system of claim 1 further comprising a master database, said master database storing (1) manufacturer promotional sample product offer criteria and (2) consumer profile data.

17. The system of claim 16 wherein said manufacturer promotional sample product offer criteria contains one or more of (1) consumer profile criteria data, (2) sample product timing criteria data, (3) manufacturer post promotional product sales goals data, (4) post promotional product sales data, (5) pre promotional product sales data, (6) fulfillment criteria data, and (7) manufacturer contract terms criteria data.

18. The system of claim 16 wherein said consumer profile data contains (1) CIDs in association with one or more of (2) consumer address data, (3) consumer demographic data, and (4) consumer purchase history data.

19. The system of claim 18 wherein said consumer purchase history data contains at least one of date and values of each consumer purchase, identification of items purchased, dates on which items were each purchased, location of each purchase, time-of-day of each purchase, frequency of each purchase, recency of each purchase, and frequencies of purchases of different brands of competing good.

20. The system of claim 1 further comprising means for generating print files for printing delivery paperwork.

21. The system of claim 1 wherein said first offer data contains consumer profile criteria data.

22. The system according to claim 1 further comprising said first retailer computer system and a first retailer purchase history database associated with said first retailer computer system, wherein said first offer data contains first offer consumer profile criteria data containing first offer consumer profile criteria, and wherein said first retailer computer system is programmed to respond to receipt of said first offer data by transmitting to said central computer system consumer profile data containing records for consumers whose consumer profile data satisfies said first offer consumer profile criteria.

23. A computer network implemented method for implementing product sampling programs, comprising the steps of:
determining in a central computer system, based at least in part on manufacturer promotional sample product criteria data, first offer data constituting a first offer for a first retailer to participate in a sampling program;
determining in said central computer system, based at least in part on manufacturer promotional sample product criteria data, second offer data constituting a second offer for a second retailer to participate in a sampling program;
transmitting from said central computer system over a communications medium said first offer data to a first retailer computer system of a plurality of retailer computer systems;
transmitting from said central computer system over said communications medium said second offer data to a second retailer computer system of said plurality of retailer computer systems;
receiving from said first retailer computer system at said central computer system first retailer consumer profile data comprising CIDs of customers of said first retailer;
receiving from said second retailer computer system at said central computer system second retailer consumer profile data comprising CIDs of customers of said second retailer;
determining at said central computer system from said first retailer consumer profile data, first retailer selected CIDs;
determining at said central computer system from said second retailer consumer profile data, second retailer selected CIDs;
wherein said first retailer selected CIDs are CIDs having data associated with them that satisfy consumer profile criteria, wherein said consumer profile criteria are based at least in part upon said manufacturer promotional sample product criteria data;
wherein said second retailer selected CIDs are CIDs having data associated with them that satisfy consumer profile criteria data, wherein said consumer profile criteria are based at least in part upon said manufacturer promotional sample product criteria data;
communicating instructions how to deliver sample products to consumers associated with said first retailer selected CIDs and said second retailer selected CIDs.

24. The method of claim 23 further comprising the steps of:
receiving at said central computer system from said first retailer computer system first retailer offer response data indicating whether a first retailer has accept, rejected, or counter offered said first offer;
receiving at said central computer system from said second retailer computer system second retailer offer response data indicating whether a second retailer has accept, rejected, or counter offered said second offer;

25. The method of claim 23 further comprising the steps of:
receiving from said first one of said retailer computer systems first retailer consumer profile data in a first data exchange data transmission format and interpreting that data based upon predetermined specification of said first one of said retailer computer systems' first data exchange data transmission format; and
receiving from said second one of said retailer computer systems second retailer consumer profile data in a second data exchange data transmission format and interpreting that data based upon predetermined specification of said second one of said retailer computer systems' second data exchange data transmission format.

26. The method of claim 23 further comprising the steps of:
determining at the central computer system, based upon said manufacturer promotional sample product criteria data and retailer identification data, offer data constituting different criteria to different retailers.

27. The method of claim 23 further comprising the steps of:
determining at the central computer system, based upon said manufacturer promotional sample product criteria data and fulfillment house availability data, offer data constituting said first offer.

28. The method of claim 23 further comprising the steps of:
if said first offer has been counter offered, determining whether to accept said counter offer based upon said manufacturer promotional sample product criteria data, and, if said determination is to accept said counter offer, then communicating that acceptance to said first one of said retailer computer systems.

29. The method of claim 23 further comprising the steps of:
transmitting from said central computer system to said first retailer computer system consumer profile criteria data containing first retailer consumer profile criteria and a prompt to said first retailer computer system to transmit to the central computer system consumer profile data meeting said first retailer consumer profile criteria.

30. The method of claim 29 further comprising the steps of:
receiving at the central computer system consumer profile data meeting said first retailer consumer profile criteria; and
determining at the central computer system CIDs from said first retailer consumer profile data that are associated with consumer profile data that meets additional consumer profile criteria, wherein said additional consumer profile criteria are in addition to consumer profile criteria transmitted to said first retailer computer system.

31. The method of claim 30 wherein said additional consumer profile criteria is retailer dependent.

32. The method of claim 30 wherein said additional consumer profile criteria contains consumer demographics criteria.

33. The method of claim 30 wherein said additional consumer profile criteria contains consumer purchase history criteria.

34. The method of claim 23 further comprising the steps of:
receiving at said central computer system from a manufacturer computer system manufacturer promotional sample product criteria data defining a request for said central computer system to solicit contracts to implement a sampling program with retailers.

35. The method of claim 23 further comprising the steps of:
determining at the central computer system CIDs having data associated with them that satisfy consumer profile criteria data, wherein said consumer profile criteria data is based at least in part on manufacturer promotional sample product criteria data.

36. The method of claim 23 further comprising the steps of:
determining at said first retailer computer system CIDs having data associated with them that satisfy criteria contained in consumer profile criteria data transmitted by said central computer system to said first retailer computer system, wherein said consumer profile criteria data is based at least in part on manufacturer promotional sample product criteria data.

37. The method of claim 23 further comprising the steps of analyzing in an analytics unit in communication with said central computer system, data to determine CIDs meeting criteria contained in consumer profile criteria data.

38. The method of claim 23 further comprising the steps of:
storing in a master database (1) manufacturer promotional sample product offer criteria and (2) consumer profile data.

39. The method of claim 38 wherein said manufacturer promotional sample product offer criteria contains one or more of (1) consumer profile criteria data, (2) sample product timing criteria data, (3) manufacturer post promotional product sales goals data, (4) post promotional product sales data, (5) pre promotional product sales data, (6) fulfillment criteria data, and (7) manufacturer contract terms criteria data.

40. The method of claim 38 wherein said consumer profile data contains (1) CIDs in association with one or more of (2) consumer address data, (3) consumer demographic data, and (4) consumer purchase history data.

41. The method of claim 40 wherein said consumer purchase history data contains at least one of date and value of consumer purchases, identification of items purchased, dates on which items were each purchased, location of each purchase, time-of-day of each purchase, frequency of each purchase, recency of each purchase, and frequencies of purchases of different brands of competing good.

42. The method of claim 23 further comprising the step of generating a file for printing delivery paperwork.

43. The method of claim 23 wherein said first offer data contains consumer profile criteria data.

44. The method of claim 23 further comprising the step of:
transmitting, in response to receipt by said first retailer computer system of first offer consumer profile criteria data containing first offer consumer profile criteria, from said first retailer computer system to said central computer system, consumer profile data containing records from a first retailer purchase history database associated with said first retailer computer system of consumers whose consumer profile data satisfies said first offer consumer profile criteria.

45. A computer program product for programming a central computer system to implement product sampling programs, comprising:
code for programming a central computer system to:
determine, based at least in part on manufacturer promotional sample product criteria data, first offer data constituting a first offer for a first retailer to participate in a sampling program;
determine, based at least in part on manufacturer promotional sample product criteria data, second offer data constituting a second offer for a second retailer to participate in a sampling program;
transmit said first offer data to a first retailer computer system of said plurality of retailer computer systems;
transmit said second offer data to a second retailer computer system of said plurality of retailer computer systems;
receive from said first retailer computer system first retailer consumer profile data comprising CIDs of customers of said first retailer;
receive from said second retailer computer system second retailer consumer profile data comprising CIDs of customers of said second retailer;
determine from said first retailer consumer profile data, first retailer selected CIDs;
determine from said second retailer consumer profile data, second retailer selected CIDs;
wherein said first retailer selected CIDs are CIDs having data associated with them that satisfy consumer profile criteria data, wherein said consumer profile criteria are based at least in part upon said manufacturer promotional sample product criteria data;
wherein said second retailer selected CIDs are CIDs having data associated with them that satisfy consumer profile criteria, wherein said consumer profile criteria are based at least in part upon said manufacturer promotional sample product criteria data;
communicate instructions how to deliver sample products to consumers associated with said first retailer selected CIDs and said second retailer selected CIDs.
